(19) United States
(12) Patent Application Publication
(10) Pub. No.: US 2012/0087661 A1
(43) Pub. Date: Apr. 12, 2012

(54) Long Distance Transmission Of Incoherent Optical Signals In An Optical Network

(76) Inventor: Christopher Michael Look, Pleasanton, CA (US)

(21) Appl. No.: 13/272,206

(22) Filed: Oct. 12, 2011

Related U.S. Application Data
(60) Provisional application No. 61/392,471, filed on Oct. 12, 2010.

(51) Int. Cl. H04J 14/02; H04J 14/06

(52) U.S. Cl. 398/65; 398/83

(57) ABSTRACT

A method and apparatus of transmitting a 10 G non-return to zero (NRZ) optical signal over a long length of single mode fiber between a 10 G NRZ optical source and a 10 G digital coherent receiver is described. A device receives a 10 G NRZ optical signal from the 10 G NRZ optical source, where the 10 G NRZ optical signal has an accumulated dispersion that is greater than a dispersion tolerance of an incoherent 10 G NRZ optical receiver. The device further recovers the 10 G NRZ optical signal using the 10 G digital coherent receiver.

### CROSS-REFERENCE TO RELATED APPLICATIONS

This application claims the benefit of U.S. provisional patent application number 61/392,471, entitled “Long Distance Transmission Of Incoherent Optical Signals In An Optical Network”, filed Oct. 12, 2010.

### BACKGROUND

1. Field

Embodiments of the invention relate to the field of processing Dense Wavelength division Multiplexed (DWDM) network traffic; and more specifically, coherent reception of non-return to zero optical signal in a reconfigurable optical add-drop multiplexer (ROADM) network.

2. Background

Currently, fiber optic systems with digital modulation typically use Non-Return to Zero (NRZ) modulation format at the transmitter (laser) combined with “direct detection” at the receiver. NRZ is a format that has the light power level alternate between a high output state to indicate, for example, a logic ‘1’ and a low output state to indicate a logic ‘0’. “Direct detection” means that the receiver only looks at the received optical power and ignores phase information of the optical signal. The choice of NRZ combined with direct detection was chosen because it was a straightforward, cheap and robust transmission scheme.

NRZ plus direct detection is widely deployed but has a few drawbacks. One drawback is that the NRZ signal can be distorted in transmission by chromatic dispersion (CD) or polarization mode dispersion (PMD), making it difficult for the receiver to determine whether a given time slot is supposed to contain a logic “1” or a logic “0”. For chromatic dispersion, the amount of distortion (dispersion) is proportional to both the bandwidth of the signal and the length of the fiber. At a datarate of 10 Gbps, some form of dispersion compensation is required to allow successful discrimination between the two logic states for fiber distances greater than a few tens of kilometers. There are several mitigation techniques used in practice. It is possible, for example, to use electronic dispersion compensation (EDC) to compensate for small amounts of CD and also PMD (which tends to be a smaller effect but is time varying). Typically, EDC is limited to distances of the order of 150 km or less because it only has the signal power, and not phase information, to work with. In amplified systems, such as would be found in typical ROADM networks, the total transmitter to receiver distances can easily exceed distances over which current EDC technology is effective. More typically then, carrier networks add an optical element, a dispersion compensating module (DCM), to the fiber that attempts to ‘undo’ (i.e. ‘compensate’) the distortion that results from transmission through the fiber. While the DCM does reverse the distortions arising from transmission through the fiber, this DCM adds cost, propagation delay, additional non-linear impairments and engineering planning

FIG. 1A (Prior Art) illustrates an optical transmitter sending a 10 G NRZ signal, a 40 Gbps DP-QPSK source and a 100 G DP-QPSK source being multiplexed and amplified in a portion of a ROADM element. The multiplexed signals are sent across a network fiber and DCM to compensate for distortion through that network fiber. The multiplexed signal is amplified and then demultiplexed and directed to the appropriate receiver—e.g. the 10 G NRZ source is delivered to a 10 G NRZ direct detection receiver for correct signal recovery. For example, in FIG. 1A, for long transmission distances (e.g. greater that 150 km), a 10 G NRZ transmitter 152D uses a DCM 104 to compensate for the impairments in the preceding length of fiber 108 80 km or greater so that the 10 G NRZ signal is equalized sufficiently to be successfully recovered by the 10 G NRZ standard signal receiver 162D. The additional loss of the DCM requires additional amplification to compensate for the loss. Often DCMs are placed in between optical amplification stages 166B-C for this purpose, which increases amplifier complexity and cost.

In FIG. 1A, the system 100 includes elements commonly found in Reconfigurable Optical Add-Drop Multiplexers (ROADMs). These elements can be assembled in different configurations but generally will include optical switching, multiplexing, demultiplexing and amplification functions. In FIG. 1A, a multiplexer 154 combines the optical signals from the coupled sources 152A-B and D. The combined signal is amplified and sent to demux 156 over a multiplexed optical fiber.

The optical signals include a combination of one or more 10 G and 10/40/100 G optical signals. For example, the 10 G signal can be a 10 G NRZ signal and the 10/40/100 G can be one of a 10 G NRZ, or 40 G, or 100 G DP-QPSK optical signal.

The multiplexer 154 is coupled to multiple optical sources 152A-C via switch 170A. For example, the multiplexer 154 is coupled, via switch 170A, to a 100 G DP-QPSK source 152A via a fiber 158A, a 40 G DP-QPSK source 152B via a fiber 158B, and a 10 G NRZ device 152D via a fiber 158D. In this example, the multiplexer 154 multiplexes the different optical signals from the optical devices 152AB and 152D and transmits the multiplexed signal to the demux 156, via booster optical amplifier 166A, over the fiber 164. The booster optical amplifier 166A boosts the optical signal bound for demux 156.

The multiplexed signal is received by DCM 104 which compensates the dispersion in the multiplexed signal and forwards this compensated signal to the demux via In one embodiment, the demux 156 directs incoming wavelengths to different output ports. In addition, the demux 156 de-multiplexes the received multiplexed signal on the multiplexed fiber 164 and forwards these the individual optical signals to switch 170B to switch the optical signals. As illustrated in FIG. 1A, demux 156 is integrated into a ROADM 172A along with optical pre-amplifier 166B, and DCM 104. The optical pre-amplifier 166B boosts the optical signal bound for demux 156. Furthermore, the ROADM 172A is able to be programmed to direct wavelengths to output ports as needed.

In addition, the demux 156 forwards, via switch 170B, a 100 G signal to a 100 G DP-QPSK receiver device 162A over a fiber 160A, a 40 G DP-QPSK receiver device 162B over a fiber 160B, and a 10 G NRZ receiver device 162D over a fiber 160D.

Furthermore, a network management station 168 configures the optical lightpaths between the sources 152AB and 152D to receivers 162AB and 162D. For example, the NMS 168 sets up optical paths for source 152A—receiver 162A using a 100 G DP-QPSK optical signal, source 152B—receiver 162B using a 40 G DP-QPSK optical signal, and source 152D—receiver 162D using a 10 G NRZ optical signal. All of these optical lightpaths go through the DCM 104.

Another drawback of NRZ modulation relates to the fact that the act of modulating the laser broadens its spectral width. For example, modulating a laser with an NRZ signal at a bit rate of B will result in the resulting signal having a bandwidth of roughly 2B. This can cause two problems:

1. As noted in the above, increasing the NRZ datarate, and hence the spectral width, by a factor of two broadens the amount of chromatic dispersion by a factor of two. However, increasing the datarate by two, means that the bit period is reduced by a factor of two. The net effect is that the effect of dispersion increases by a factor of four—or more generally, the dispersion tolerance decreases as (bit rate)². As the NRZ bit rate increases, from 10 Gbps to 40 Gbs and 100 Gbps, this becomes severely limiting.

2. Other system can use 50 GHz channel spacing to put more wavelengths on the fiber. It becomes increasingly difficult to do this with NRZ modulation as the bit rate approaches the channel spacing. The optical filters that are used to enforce the channel spacing in such a system significantly distort 40 Gbps and 100 Gbps NRZ signals, resulting in very short reach.

For transmission rates of 40 Gbps and 100 Gbps, a more complex phase modulation transmission scheme called dual-polarization quadrature phase shift keying (DP-QPSK) is currently being proposed and used. This has the significant benefit of reducing the signal bandwidth by a factor of four: a factor of two reduction results because in this modulation scheme, two polarization states are used and a second factor of two results from using signal phase in addition to amplitude. The net effect of the above is that, for example, a 40 Gbps signal can be sent with four independent signals each running at 10 Gbps. Hence, a 40 Gbps signal employing DP-QPSK modulation can be transmitted across a transmission link with Mux and Demux filters originally designed for 10 Gbps.

At the receive end, this DP-QPSK signal needs to be recovered. The modulation scheme requires that this reception be done ‘coherently’ —e.g., a local laser oscillator (LO) that is ‘close’ to the lasing frequency of the transmit laser is mixed with the incoming signal. If the LO has a frequency sufficiently close to that of the transmit laser and the frequency difference between the two does not change much during a bit period, the signal is said to be ‘coherently’ detected and the signal phase can be recovered in addition to its amplitude.

A DP-QPSK signal can be recovered by using complex calculations running in high-speed electronic digital signal processing (DSP) chips. Current day CMOS technology enable sufficient processing power to be packed into a chip such that the polarization states and LO/transmit laser frequency offsets can be identified and tracked electronically. As critically, the coherent nature of reception gives information about the signal phase as well as amplitude. This means that, with the right algorithms, different linear impairments (CD, PMD, filter narrowing, frequency response of modulators or photodetectors, etc.) can be compensated for by the same DSP. Commercial systems employing DP-QPSK with coherent detection are now available that operate over 3,000 km at 40 Gbps. DP-QPSK can also be used for 100 Gbps systems.

Unfortunately, there are problems when attempting to run both 10 G NRZ and DP-QPSK on the same fiber. The refractive index of the fiber is not constant but can change with power level. In a ‘homogeneous’ transmission system, where all the signals are DP-QPSK encoded, these impairments can be small. The reason is that the DP-QPSK signal is always on—the information is encoded in the signal phase. Hence, any changes in the refractive index are effectively “constant” and appear as a fixed change in fiber length, which the DSP is able to accommodate easily.

In contrast, an NRZ signal is always turning its power on and off and hence, its effect on the refractive index changes from bit to bit. The effect is that the speed of a co-propagating optical signal C will change depending on whether signal A happens to be a “0” or a “1” (signals C and A are at different wavelengths in the same fiber). The effect of this speed change is a change in phase—a serious problem for DP-QPSK signal, which uses phase encoding to differentiate a logic ‘0’ from a logic ‘1’. The effect increases with the number of amplifiers (and indirectly, the end-end distance) and with decreasing channel spacing. The effect is a serious one which limits the ability of 10 G NRZ to co-exist with DP-QPSK signals, particularly for extended reach applications (e.g. >hundreds of km) and 50 GHz channel spacing.

A number of approaches have been suggested in the industry to deal with this problem:

1. Keep the signals separate. Put DP-QPSK on one fiber and NGZ on a different fiber. This approach is expensive and forever keeps the networks separate.

2. Put a “guard band” of unused channels between the NRZ and DP-QPSK signals. The problem with this is that it greatly restricts the wavelengths assignments and it is very difficult to shift the guard band over time as technology and needs change.

3. Live with the impairments. Use of conservative design rules will significantly shorten the reach of the DP-QPSK signals.

### SUMMARY

A method and apparatus of transmitting a 10 G non-return to zero (NRZ) optical signal over a long length of single mode fiber between a 10 G NRZ optical source and a 10 G digital coherent receiver. A device receives a 10 G NRZ optical signal from the 10 G NRZ optical source, where the 10 G NRZ optical signal has a dispersion that is greater than a dispersion tolerance of an incoherent 10 G NRZ optical receiver. The device further recovers the 10 G NRZ optical signal using the 10 G digital coherent receiver.

### BRIEF DESCRIPTION OF THE DRAWINGS

The invention may best be understood by referring to the following description and accompanying drawings that are used to illustrate embodiments of the invention. In the drawings:

FIG. 1A (Prior Art) illustrates an optical transmitter sending a 10 G NRZ signal, a 40 Gbps DP-QPSK source and a 100 G DP-QPSK source being multiplexed and amplified in a portion of a ROADM element.;

FIG. 1B illustrates a system that multiplexes multiple 10 G and 10/40/100 G optical signals and de-multiplexes these optical signals to corresponding receivers according to one embodiment of the invention;

FIG. 2 illustrates a multiplexer that multiplexes multiple 10 G and 10/40/100 G signals to a digital coherent receiver according to one embodiment of the invention;

FIG. 3 illustrates an exemplary flow diagram of detecting and routing 10 G non-coherent and 10/40/100 G coherent optical signals that were multiplexed according to one embodiment of the invention;

FIG. 4 illustrates an exemplary flow diagram of routing a 10 G optical signal according to one embodiment of the invention;

FIG. 5 illustrates performance of different optical signals over a 1280 km link according to one embodiment of the invention;

FIG. 6 illustrates power margin of an optical signal against a required Q-factor according to one embodiment of the invention;

FIG. 7 is a block diagram illustrating an exemplary digital signal processor that can detect and route 10 G and 10/40/100 G signals that were multiplexed as used in FIG. 2 according to one embodiment of the invention;

FIG. 8 is a block diagram illustrating an exemplary 10 G optical signal processing module that can route a 10 G signal as used in FIG. 7 according to one embodiment of the invention;

FIG. 9 is a block diagram illustrating an exemplary network element that can detect and route 10 G and 10/40/100 G signals that were multiplexed as used in FIG. 2 according to one embodiment of the system; and

FIG. 10 is a block diagram of an OOK coherent receiver hardware 1000 according to one embodiment of the invention.

### DETAILED DESCRIPTION

The following description describes methods and apparatus of method and apparatus of processing a plurality of optical signals. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The operations of this and other flow diagrams will be described with reference to the exemplary embodiments of the other diagrams. However, it should be understood that the operations of the flow diagrams can be performed by embodiments of the invention other than those discussed with reference to these other diagrams, and the embodiments of the invention discussed with reference these other diagrams can perform operations different than those discussed with reference to the flow diagrams.

The techniques shown in the figures can be implemented using code and data stored and executed on one or more electronic devices (e.g., an end station, a network element, etc.). Such electronic devices store and communicate (internally and/or with other electronic devices over a network) code and data using machine-readable media, such as machine-readable storage media (e.g., magnetic disks; optical disks; random access memory; read only memory; flash memory devices; phase-change memory) and machine-readable communication media (e.g., electrical, optical, acoustical or other form of propagated signals—such as carrier waves, infrared signals, digital signals, etc.). In addition, such electronic devices typically include a set of one or more processors coupled to one or more other components, such as one or more storage devices, user input/output devices (e.g., a keyboard, a touchscreen, and/or a display), and network connections. The coupling of the set of processors and other components is typically through one or more busses and bridges (also termed as bus controllers). The storage device and signals carrying the network traffic respectively represent one or more machine-readable storage media and machine-readable communication media. Thus, the storage device of a given electronic device typically stores code and/or data for execution on the set of one or more processors of that electronic device. Of course, one or more parts of an embodiment of the invention may be implemented using different combinations of software, firmware, and/or hardware.

A method and apparatus of processing a 10 G NRZ optical signal is described. A device receives a 10 G NRZ optical signal from a 10 G NRZ optical source, where the 10 G NRZ optical signal has an accumulated dispersion that is greater than a dispersion tolerance of an incoherent 10 G NRZ optical receiver. The device further recovers the 10 G NRZ optical signal using a 10 G digital coherent receiver.

In one embodiment, a method receives the plurality of optical signals on a single fiber, wherein the plurality of optical signals includes a mix of optical signals intended for both coherent and non-coherent reception (detection and demodulation). For each of the plurality of optical signals, the method determines if that optical signal requires a coherent or a non-coherent reception. If that optical signal requires coherent processing, the method switches that signal to a coherent receiver. If that optical signal has a signal quality (OSNR) that is sufficiently high that it does not require coherent processing, the method switches that optical signal to a non-coherent receiver.

In another embodiment, a network comprises a multiplexer, a plurality of optical receivers, and a digital coherent receiver. The multiplexer transmits a multiplexed optical signal, wherein the multiplexed optical signal includes a mix of phase and intensity modulated optical signals. The plurality of optical receivers includes a coherent optical receiver that coherently receives an optical signal and a non-coherent optical receiver that receives a signal using non-coherent reception. The digital coherent receiver, coupled to the multiplexer and the plurality of optical receivers, receives the multiplexed optical signal, and, for each of the plurality of optical signals, determines if that optical signal requires coherent or a non-coherent processing, wherein if that optical signal is phase modulated or otherwise requires coherent optical signal reception, switches that signal to a coherent receiver, and if that optical signal does not require coherent processing, switches that optical signal to a non-coherent receiver.

In a further embodiment, a network element to process a plurality of optical signals in a Dense Wavelength Division Multiplexing (DWDM) system is described. The network element includes a first port, a plurality of other ports, and a digital signal processor. The first port, to be coupled to a demultiplexer, is to receive the plurality of optical signals on a single fiber, where the plurality of optical signals includes a mix of phase and intensity modulated optical signals. The plurality of other ports, to be coupled to a plurality of optical receivers, is to transmit the mix of phase and intensity optical signals to the plurality optical receivers. The digital signal processor, to be coupled to the first port and the plurality of other ports, for each of the plurality of optical signals, is to determine if that optical signal is a coherent or a non-coherent optical signal. The control plane configures the optical switches that if optical signal requires coherent optical signal processing, to switch that signal to a coherent receiver. Furthermore, if that optical signal is a non-coherent optical signal, the control plane configures the optical switches to switch that optical signal to a non-coherent receiver.

A network device receives the plurality of optical signals on a single fiber, where the plurality of optical signals includes a mix of dual-polarization quadrature phase shift keying (DP-QPSK) and Non-Return to Zero (NRZ) optical signals. The network device has sufficient knowledge of the source and terminating equipment so that it is able to route, for example, an incoming DP-QPSK signal to the desired DP-QPSK receiver. The network device has determined the dispersion tolerance of an NRZ receiver and an estimate of the dispersion of the end-end lightpath. If a signal is an NRZ signal and a calculated dispersion of that signal is within a dispersion tolerance of a direct detection NRZ receiver, the network device switches that signal to the NRZ receiver. If it is not within the dispersion tolerance of that receiver, it will route that optical signal to a coherent receiver where the NRZ is recovered. The recovered NRZ signal is used directly or, alternatively, to modulate a second, lower cost laser and send that signal across a short fiber link to the direct detection NRZ receiver.

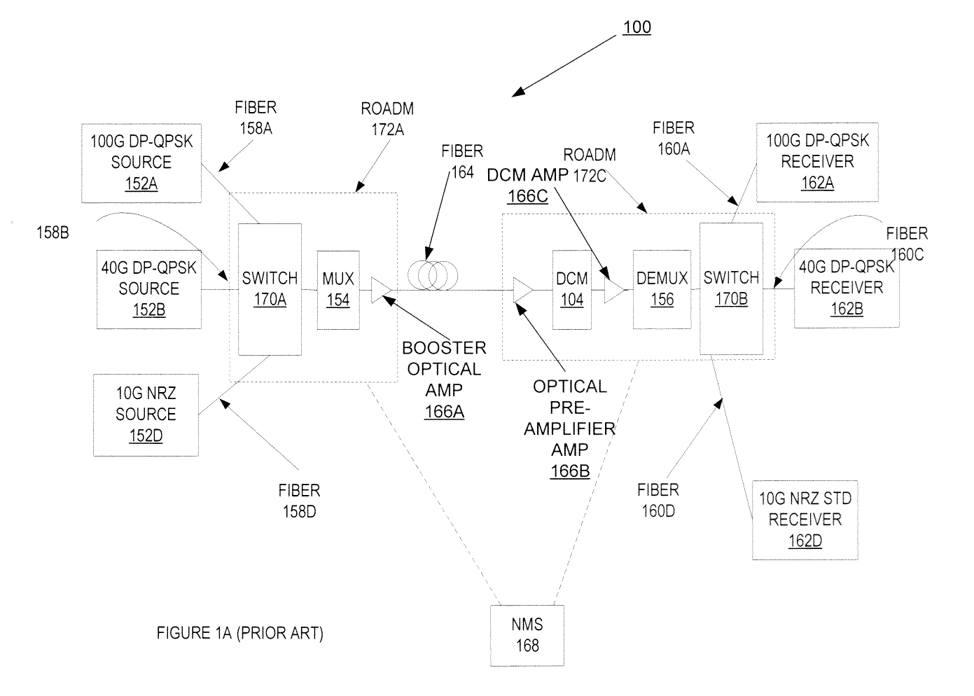

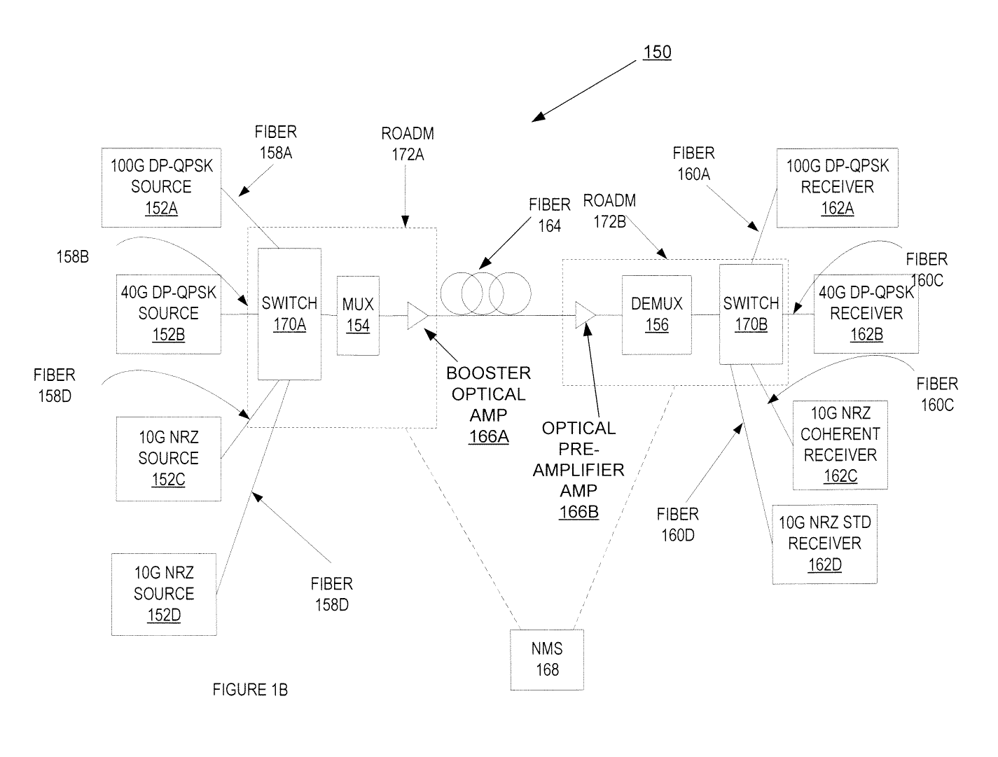

FIG. 1B illustrates a system 150 that multiplexes multiple 10 G non-coherent and 10/40/100 G coherent optical signals and de-multiplexes these optical signals to corresponding receivers without the use of a DCM according to one embodiment of the invention. In one embodiment, a coherent optical signal is an optical signal that is received coherently (e.g., DP-QPSK, etc.). A non-coherent optical signal is an optical signal that does need to be received coherently (e.g., NRZ, etc.). In FIG. 1B, the system 150 includes elements commonly found in Reconfigurable Optical Add-Drop Multiplexers (ROADMs). These elements can be assembled in different configurations but generally will include optical switching, multiplexing, demultiplexing and amplification functions. In FIG. 1B, a multiplexer 154 combines the optical signals from the coupled sources 152A-D. The combined signal is amplified and sent to demux 156 over a multiplexed optical fiber. While in one embodiment, the multiplexer 154 multiplexes the different optical signals into a DWDM optical signal, in alternate embodiments, the multiplexer 154 multiplexes the different optical signals in another type of multiplexed optical signal (e.g., wavelength-division multiplexing (WDM), etc.). In one embodiment, the multiplexed optical signals are spaced into 50 GHz channels. In this embodiment, the mix of coherent and non-coherent optical signals need not be separated by a guard band of unused optical channels.

In one embodiment, the optical signals can includes a combination of one or more 10 G and 10/40/100 G optical signals. For example and in one embodiment, the 10 G signal can be a 10 G NRZ signal and the 10/40/100 G can be one of a 10 G, 40 G, or 100 G DP-QPSK optical signal. Furthermore, the system 150 does not require a DCM as is used in FIG. 1A.

In one embodiment, the multiplexer 154 is coupled to multiple optical sources 152A-C via switch 170A. For example and in one embodiment, the multiplexer 154 is coupled, via switch 170A, to a 100 G DP-QPSK source 152A via a fiber 158A, a 40 G DP-QPSK source 152B via a fiber 158B, a 10 G NRZ source 152C via a fiber 158C, and a 10 G NRZ device 152D via a fiber 158D. In one embodiment, the multiplexer 154 multiplexes the different optical signals from the optical devices 152A-D and transmits the multiplexed signal to the demux 156, via booster optical amplifier 166A, over the fiber 164. In one embodiment, the booster optical amplifier 166A boosts the optical signal bound for demux 156. While in one embodiment, the fiber 164 is a standard single-mode fiber, in alternate embodiment different types of single mode optical fibers can be used (e.g., dispersion shifted fiber, non-zero dispersion shifted fiber, and/or other suitable fiber as known in the art.). While in one embodiment, the switch 170A, mux 154, and booster 166A are included in a ROADM 172A, in alternate embodiments, the switch 170A, mux 154, and/or booster 166A can be in separate devices, or some combination thereof.

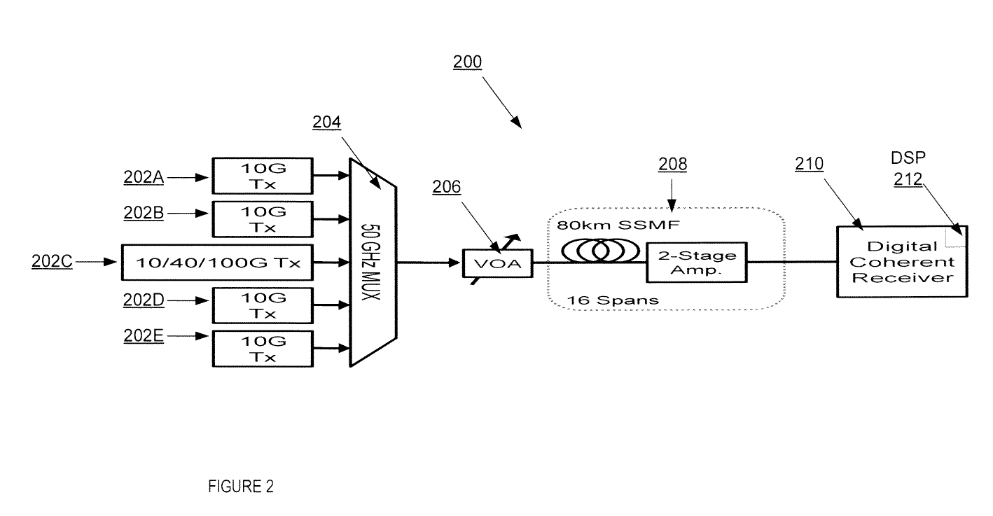

In one embodiment, the demux 156 directs incoming wavelengths to different output ports. In one embodiment, the demux 156 de-multiplexes the received multiplexed signal on the multiplexed fiber 164 processes the different type of signals. How the demux 156 handles the different types of signals is further described in FIGS. 2-4 below. In one embodiment, demux 156 is integrated into a ROADM 172B along with optical pre-amplifier 166B. In one embodiment, the optical pre-amplifier 166B boosts the optical signal bound for demux 156. In this embodiment, the ROADM 172B is able to be programmed to direct wavelengths to output ports as needed. In another embodiment, a plurality of signals can be delivered to a coherent receiver (162A, 162B or 162C) and the desired signal selected by tuning the receiver's local oscillator to the correct frequency. This capability moves some or all of the demultiplexing functionality into the receiver itself.

In one embodiment, the demux 156 forwards, via switch 170B, a 100 G signal to a 100 G DP-QPSK receiver device 162A over a fiber 160A, a 40 G DP-QPSK receiver device 162B over a fiber 160B, a 10 G coherent receiver device 162C over a fiber 160C, and a 10 G NRZ receiver device 162D over a fiber 160D. In one embodiment, by using 10 G NRZ coherent receiver 162C, system 150 does not require a DCM to receive the 10 G NRZ signal.

In one embodiment, a NMS 168 configures the optical lightpaths between the sources 152AB and 152D to receivers 162AB and 162D. For example, the NMS 168 sets up optical paths for source 152A—receiver 162A over a 100 G DP-QPSK optical signal, source 152B—receiver 162B over a 40 G DP-QPSK optical signal, NRZ source 152C—coherent receiver 162C over a 10 G NRZ optical signal, and source 152D—receiver 162D over a 10 G NRZ optical signal. Unlike in FIG. 1A above, these lightpaths do not go through a DCM 104.

In one embodiment, there is a pair of multiplexer 154 and demux 156 that is used to communicate the optical signals in each direction to and from the optical devices 152A-D and 162A-D.

FIG. 2 illustrates a network 200 that includes a multiplexer 204 that multiplexes multiple 10 G, 40 G and 100 G signals 202A-E to network fiber 208. For clarity, the central laser 202C alone is connected through the optical path to a 10 G digital coherent receiver 210. In FIG. 2, the DCM is removed from the network 200. As described above, DP-QPSK systems do not require the use of the DCM, as the DCM is used primarily to recover NRZ signals. By design, the DCMs act to ‘square up’ the NRZ signals. This “squaring up” maximizes the difference between the logic “0” and logic ‘1’ states, and increases the non-linear phase issues. Removal of the DCMs, allows the NRZ signal to “smear out” with distance, which will mitigate the non-linear effects. Normally, removal of the DCM will result in the 10 G NRZ signal being distorted and degraded. In the current situation, the use of a 10 G coherent digital receiver is used to compensate for very large amounts of distortion and recover the digital information contained in the original 10 G NRZ signal. In one embodiment, a ROADM can include multiplexer 204, and/or digital coherent receiver 210.

In one embodiment, the 10 G digital coherent receiver 210 includes coherent receivers similar to those developed for 40 Gbps DP-QPSK receivers modified to process the 10 Gbps NRZ signal. The DSP algorithm in the digital coherent receiver 210 recovers an NRZ signal instead of a DP-QPSK one, and the polarization tracking, phase detection, and linear distortion compensation for an NRZ signal are similar to such treatment for a DP-QPSK signal. The digital coherent receiver 210 with the modified DSP algorithm is thus able to receive the “smeared out” NRZ signal and recover it. In effect, it is a coherent form of EDC, which is able to use phase as well as amplitude information and hence is much more powerful than its incoherent EDC form, which as noted earlier is restricted to working with power (i.e. no phase information) and hence, much shorter distances.

The transmitters that transmit the 10 G NRZ (not illustrated in FIG. 2) signal are 10 G NRZ transmitters as known in the art. The system would propagate that signal across the network and perform coherent reception at the egress of the optical network. This allows existing 10 G NRZ transmission modules to be used in both directions without changes. In one embodiment, use of coherent reception means that lower cost NRZ transmitters (e.g. Electro-Absorption (EA) modulators), which have had limited reach when originally specified and deployed, can be used over much longer distances more typically associated with more expensive electro-optic modulators.

After reception and processing by the DSP 212, a clean NRZ signal is recovered. That NRZ signal can be processed directly or used to directly modulate another laser, which is, in turn, sent to a terminating standard NRZ receiver. In one embodiment, where the terminating receiver is directly connected to the coherent receiver over fiber of distance of up to 40 km (expected to be the majority of the cases), a simple low cost directly-modulated laser can be used for this purpose. In another embodiment, where the terminating receiver is connected through an extended ROADM network of unknown impairments, this NRZ signal will modulate a DWDM laser. Note that in the other direction, the incoming 10 G NRZ signal is received with the coherent receiver as with any other 10 G NRZ signal are described above. Thus, the approach as described can be used to enable transmission through ROADM networks supplied by more than one vendor—something that is not done today due to uncertainties of the impairments in the disparate networks.

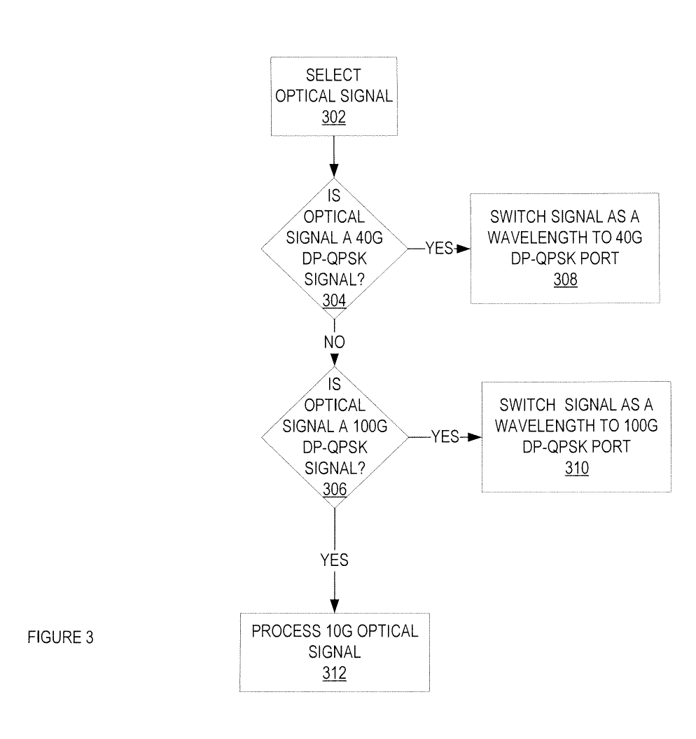

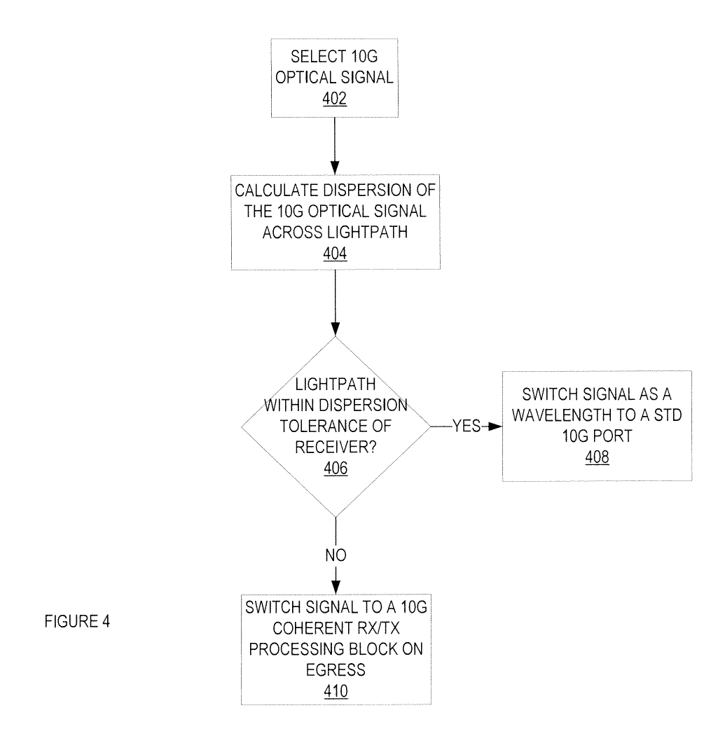

In one embodiment, not all NRZ DWDM signals will need this treatment. For example, and in one embodiment, an approach allows communication of the optical network control plane with the end transmitters. This communication can be either ‘out-of-band’ (where a separate physical medium from the fiber used to carry the DWDM signal is used) and/or ‘in-band’(where communication is over the same physical fiber as the DWDM signal). Either approach will work providing that the communication enables the optical network control plane to gather information about the end transceivers to provide a routing engine with information concerning the dispersion tolerance of the DWDM signal. The routing engine can make the following determination: if the signal originates from is a 40 G DP-QPSK module, switch that signal as a wavelength to a port connected to a like 40 G DP-QPSK receiver; if the signal originates from a 100 G DP-QPSK module, switch that signal as a wavelength to a port connected to a like 100 G DP-QPSK receiver; if the signal originates from a 10 G NRZ module, look at the dispersion tolerance of that receiver, and calculate the dispersion expected for proposed lightpaths; if a lightpath can be found that is within the dispersion tolerance of the receiver, switch that signal as a wavelength to a port connected to a like 10 G NRZ receiver; and if no such lightpath can be found, switch the signal to a coherent Rx/Tx processing block on egress. The process in which the routing engine makes the following determinations is further described in FIGS. 3 and 4 below.

FIG. 3 illustrates an exemplary flow diagram of a process 300 to configure 10 G and 10/40/100 G signals that were multiplexed according to one embodiment of the invention. In one embodiment, the network management system 168 performs process 300 to configure demux 156 and/or swtich 170B, so as to set up lightpaths to route the different types of optical signals received by demux 156. In FIG. 3, process 300 begins by receiving the optical signal at block 302. In one embodiment, the optical signal can be one of many different types of optical signals, (100 G DP-QPSK, 40 G DP-QPSK, 10 G DP-QPSK, 10 NRZ, etc. or another type of optical signal as known in the art). In one embodiment, the optical signal is one of a plurality of optical signals that was part of a multiplexed signal (e.g., DWDM, WDM, etc.).

At block 304, process 300 determines if the optical signal originated from a 40 G DP-QPSK module. For example and in one embodiment, the optical signal originates from 40 G DP-QPSK source 152B as described in FIG. 1B above. In one embodiment, is that process 300 compares the modulation type and rate of the source and makes sure that modulation type and rate matches the capabilities of the receiver. For example and in one embodiment, a 40 G source with modulation DP-QPSK & a FEC of type 4f will only be connected to a 40 G receiver that matches it. There could be a 40 G source with modulation DP-QPSK but a different FEC and process 300 does not allow the connection because of FEC mismatch. If the optical signal is from a 40 G DP-QPSK module, at block 308, process 300 switches this optical signal as a wavelength to a 40 G DP-QPSK port. In one embodiment, process 300 routes the corresponding wavelength of the detected 40 G DP-QPSK optical signal to a port that can transmit this wavelength.

If the optical signal did not originate from a 40 G DP-QPSK module, process 300 proceeds to block 306 below.

At block 306, process 300 determines if the optical signal originated from a 100 G DP-QPSK module. For example and in one embodiment, the optical signal originates from 100 G DP-QPSK source 152A as described in FIG. 1B above. If the optical signal is from a 100 G DP-QPSK module, at block 310, process 300 switches this optical signal as a wavelength to a 100 G DP-QPSK port. In one embodiment, process 300 routes the corresponding wavelength of the detected 100 G DP-QPSK optical signal to a port that can transmit this wavelength. If the optical signal did not originate from a 100 G DP-QPSK module, process 300 proceeds to block 312 below.

At block 312, process 300 processes this optical signal. In one embodiment, process 300 determines if this optical signal is a phase modulated signal or a NRZ signal. Processing the 10 G optical signal is further described in FIG. 4 below.

As described above, an optical signal originating from a standard 10 G DWDM module is expected to be received with non-coherent optical receiver that just looks at the total power, ignoring phase information. However, the optical signal leaving the transmitter is already polarized and has a narrow linewidth. The linewidth is typically not as controlled as a laser intended for use in 40 G DP-QPSK transmitters but nonetheless is sufficiently narrow to allow a remote local oscillator to lock to it. This means that the NRZ signal can be received by a coherent receiver (comprising a tunable local oscillator, two optical hybrids, quad photodetectors and amplifiers) and those four signals processed by a DSP, similar to one used for 40 G DP-QPSK but modified to demodulate a single NRZ signal instead of quad QPSK ones.

FIG. 4 illustrates an exemplary flow diagram of a process to route a 10 G signal according to one embodiment of the invention. For example and in one embodiment, a NMS, such as NMS 168 of FIG. 1B above performs process 400. In FIG. 4, process 400 begins by receiving the 10 G optical signal at block 402. At block 404, process 400 calculates the dispersion of the 10 G optical signal. In one embodiment, process 400 calculates the optical dispersion by a control plane of the demux using the knowledge of fiber length and fiber type. For example and in one embodiment, for G.652 fiber, the dispersion per meter is nominally 17 ps/kn-m. Multiplying by the fiber length will give the calculated dispersion. For example, a 100 km fiber will have 1,700 ps/nm dispersion. Process 400 compares this calculated dispersion with the ‘dispersion tolerance’ of the transceiver to see if it can handle this on its own. If not, the lightpath is routed to the 10 G coherent receiver to recover the signal. In one embodiment, the recovered optical signal can directly modulate a laser that is within the dispersion tolerance of the 10 G standard receiver.

At block 406, process 400 determines if there is a lightpath found with a dispersion tolerance of a 10 G receiver. In one embodiment, the 10 G receiver is a receiver that can receive a 10 G optical signal, such as 10 G NRZ optical receiver 162D as illustrated in FIG. 1A above. For example and in one embodiment, process 400 compares the calculated dispersion of the lighpath to the dispersion tolerance of the a standard 10 G receiver. If there is a lightpath found, at block 408, process 400 routes this optical signal as a wavelength to a 10 G standard port. For example and in one embodiment, if no lightpath is found, at block 406, process 400 switches this optical signal to a coherent transceiver processing block on an egress port. In one embodiment, the lightpath is routed to the 10 G coherent receiver to recover the signal. In one embodiment, the recovered optical signal can directly modulate a laser that is within the dispersion tolerance of the 10 G standard receiver.

In one embodiment, as described below, the system 200 can find a launch power that (a) is substantially the same for 10 G NRZ, 40 G DP-QPSK and 100 G DP-QPSK signals and (b) allows these signal to be received with sufficient margin over distances up to 1280 km. This means that the above signals can be randomly mixed without changing the total power seen by any erbium doped fiber amplifiers (EDFA) in the network. This means that EDFAs do not have to be altered as coherent signals become more and more prevalent in the network. Furthermore, this allows a mix of coherent and non-coherent optical signals to be transmitted over the same optical fiber. In addition, the system does not require the use of a guard band of unused optical channels to transmit this mix of optical signals. This allows the system to transmit coherent and non-coherent optical signals on adjacent optical channels.

As described above, the system 200 can transmit and receive a hybrid of DP-QPSK and NRZ signals on a single fiber. In one embodiment, two alternate network configurations are modeled, to isolate and illustrate the effect of the Kerr nonlinearity on the system 200 considered. In this embodiment, the two networks are one with a DCM (e.g., similar to the system 100 as illustrated in FIG. 1A) and a network without a DCM (e.g., similar to the system 150 as illustrated in FIG. 1B). Both network models consisted of a 16 span link, with dual-stage amplification. In this embodiment, the system with inline optical dispersion compensation was chosen to have a perfect and linear dispersion compensation module (DCM) mid-stage, while the non-dispersion compensated system was assumed to have an attenuator mid-stage to keep the ASE impairment the same for the two systems. This ensured that the delivered optical signal to noise ratio (OSNR) that was substantially identical for both systems and to isolate the performance benefit due to the reduction in optical nonlinear effects in a multiplexed optical signal.

The multi-wavelength transmitter was considered to be capable of arbitrary combinations of 112 Gb/s DP-QPSK; 42.8 Gb/s DP-QPSK; and 10.7 Gb/s OOK (referred to as 100 G, 40 G and 10 G respectively in FIG. 2). Modulation formats considered including on-off keyed (OOK) non-return-to-zero (NRZ) were detected coherently to maximize the comparability of the different systems. FIG. 2, as described above, illustrates the link architecture. In one embodiment, while the use of dual-stage amplifiers with high mid-stage loss over an uncompensated link may lead to a pessimistic measure of performance for the non-dispersion managed case, the effects of removing optical dispersion compensation on the nonlinear transmission performance may be more easily isolated if performance is assessed with equal Optical Signal to Noise (OSNR) delivered.

Nonlinear simulations of the network were performed in order to compare the relative performance of the different network configurations with and without inline dispersion compensation under nonlinear transmission. Finite transmitter bandwidth was modeled with a 5^{th} order Bessel filter with a bandwidth of 0.7 of the baud rate. The electrical driving signals were mapped into the optical domain with a Mach-Zehnder modulator (MZM) in the case of On-Off Keyed (OOK) and a nested triple MZM in the case of DP-QPSK.

The signals were propagated over 16 spans of SSMF, which had length of 80 km; dispersion of 17 ps/nm/km; loss of 0.25 dB/km; dispersion slope of 0.089 ps/nm²/ km and a nonlinearity coefficient of 1.2/W/km. Fiber propagation was simulated with an adaptive step split-step Fourier method with a maximum nonlinear phase shift of 3 mrad per nonlinear step. Each amplifier had a noise figure of 6 dB; a gain of 20 dB was used to compensate the span loss and a second stage gain of 18 dB was used to compensate the insertion loss of the DCM, resulting in an overall effective noise figure of 8.1 dB for both amplifier configurations. The optional mid-stage DCM was modeled as an ideal linear dispersive element which provides the opposite dispersion and dispersion slope of the preceding span.

The 10 G coherent receiver was modeled as a direct-detection receiver with a bandwidth of 0.7 of the symbol rate and a perfectly aligned polarizing filter. This allows to emulate s significant performance benefit of using a coherent receiver without using specific digital signal processing algorithms. The signal was sampled with optimum sampling phase, and the decision threshold was swept to infer the maximum Q-factor. The 40 G and 100 G receivers were both modeled as perfectly homodyned, balanced coherent receivers with infinite common-mode rejection ratio. The photodiodes were again assumed to have a bandwidth of 0.7 of the symbol rate. The signal was decimated to two samples per symbol, and normalized in preparation for processing. The signal was equalized using the CMA algorithm with LMS updating in order to remove ISI due to filtering. Q-factor was inferred by resolving each DP-QPSK signal into four real valued tributaries, each of which yielded a Q estimation via the means and variances of each transmitted bit-stream. Each Q-factor estimate was converted into an inferred BER, and all four BER estimates were averaged before being converted into a final estimate of Q-factor.

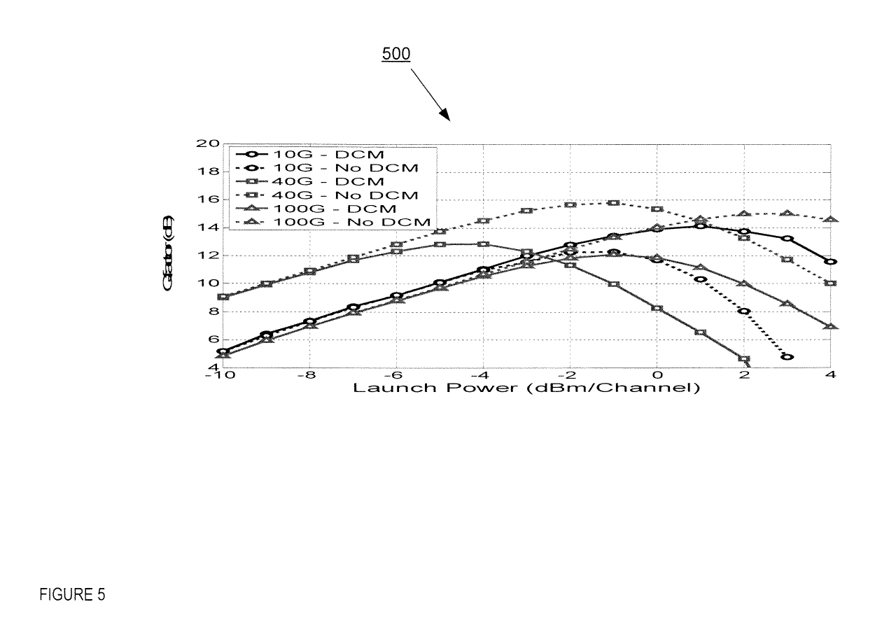

The performance of the transmission system was examined at 16 spans (1280 km) for the cases of all 10 G (the “homogeneous” case), as well as the ‘hybrid’ cases of 40 G and 100 G DP-QPSK being the signal of interest 202C with 10 G aggressors (202A, 202B, 202D, 202E). In each case, the performance of the central channel was compared when using amplifiers with and without mid-stage dispersion compensation. FIG. 5 plots the Q factors of the central signals for all the above six cases. The removal of dispersion management results in a reduction in the optimum Q-factor for the 10 G homogeneous link from 14.1 dB to 12.2 dB. This is due to the ambivalence to nonlinear phase distortions of OOK modulation, except when they are converted from the phase to amplitude domain by dispersion. Conversely, the performance of the hybrid DP-QPSK links is improved by removing the inline dispersion management. For the 40 G DP-QPSK link, the maximum Q-factor is increased from 12.8 dB to 15.8 dB, while for the 100 G link, maximum Q-factor is improved from 12.0 dB to 15.0 dB.

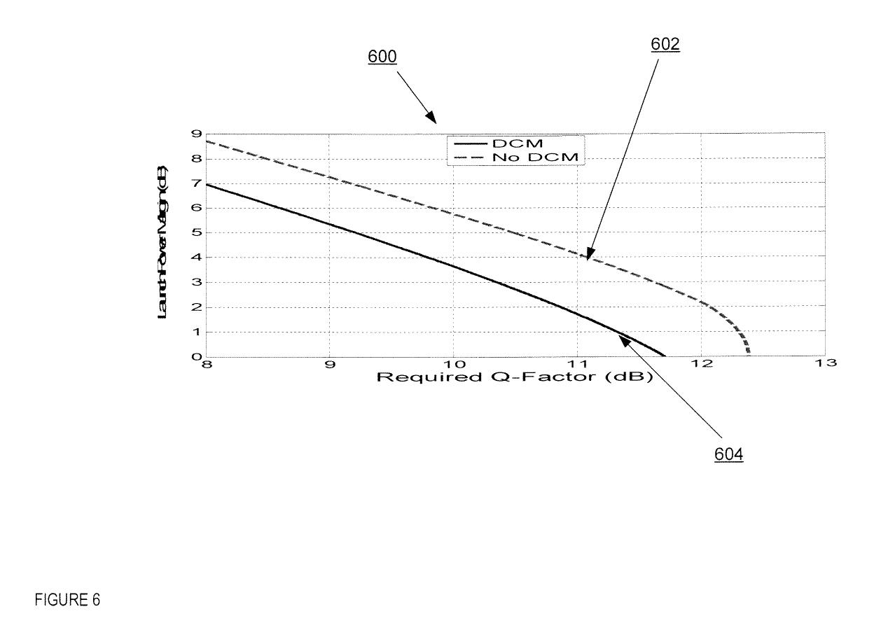

To provide a more detailed analysis of the performance of the various line rates over the different link topologies, a polynomial fit was performed to each of the above curves using a heuristic as known in the art. The minimum Q-factor of all three systems was extracted over each link, and launch power margin (that is, the range of launch powers for which a given required Q-factor may be maintained) was plotted against required Q-factor (that is, the minimum Q-factor on all systems at a given launch power). The result is plotted in FIG. 6.

It is apparent from FIG. 6 that the system without inline dispersion compensation 602 is superior for different Q-factors than for the system with a DCM 604. A typical example of a required Q-factor of 11.5 dB (8.5 dBQ FEC limit, 3 dB operating margin) yields little or no power margin when inline dispersion compensation is used, and approximately 3 dB of launch power margin without dispersion compensation.

For a system where legacy wavelengths intended for direct detection are co-existent with coherently detected wavelengths at 40 G and 100 G, performance may be significantly improved by removing inline optical dispersion compensation and coherently detecting all channels. At 1280 km (16 spans) this resulted in a performance improvement of 2.6 dBQ for 40 G, 2.6 dB for 100 G and a degradation of 1.9 dB for 10 G.

For the dispersion managed link, little or no launch power margin exists for the required Q-factor (11.5 dBQ). Conversely, when optical dispersion management is removed, there exists a window of approximately 3 dB for which all links considered maintain the desired level of performance. This is a conservative measure of the improvement in performance that is possible, as the improvement in delivered OSNR with single-stage amplifiers, reduction in nonlinearity, which is possible when dispersion compensating fiber is removed from the optical plant, and the reduction of ISI when digital equalization is performed with coherently detected 10 G has not been considered. As compared to other approaches to DCM removal (such as pre-compensation, etc.), the approach described does not require the feedback across the network, is fully adaptive at the receive side only and, most importantly, should simplify the migration of carrier networks by enabling an arbitrary mix of 10 G NRZ and 40 G/100 G DP-QPSK signals.

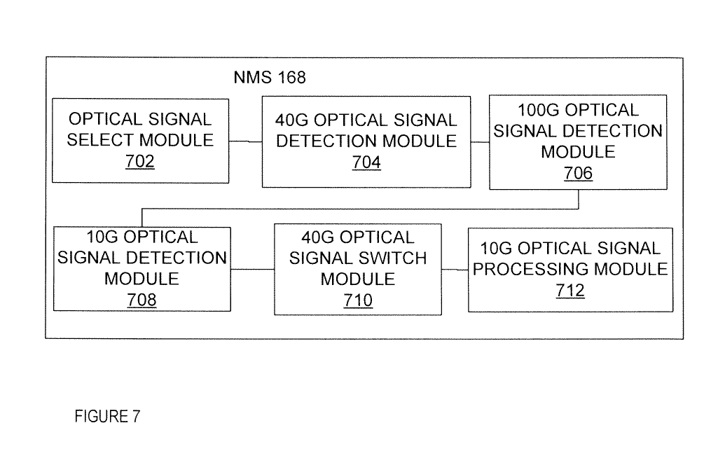

FIG. 7 is a block diagram illustrating an exemplary network management system 168 that can configure devices to multiplex and demultiplex 10 G and 10/40/100 G signals as used in FIG. 1B according to one embodiment of the invention. In FIG. 7, network management system 168 includes optical signal selection module 702, 40 G optical signal detection module 704, 100 G optical signal detection module 706, 40 G optical signal switch module 708, 100 G optical signal switch module 710, and 10 G optical signal processing module 712. In one embodiment, optical signal receiving module 702 selects the optical signal as described above in FIG. 3, block 302. In one embodiment, 40 G optical signal detection module 704 detects a 40 G optical signal as described above in FIG. 3, block 304. In one embodiment, 100 G optical signal detection module 706 detects a 100 G optical signal as described above in FIG. 3, block 306. In one embodiment, 40 G optical signal switch module 708 switches the optical signal as a wavelength to a 40 G port as described above in FIG. 3, block 308. In one embodiment, 100 G optical signal switch module 710 switches the optical signal as a wavelength to a 100 G port as described above in FIG. 3, block 310. In one embodiment, 10 G optical signal processing module 712 processes a 10 G optical signal as described above in FIG. 3, block 312.

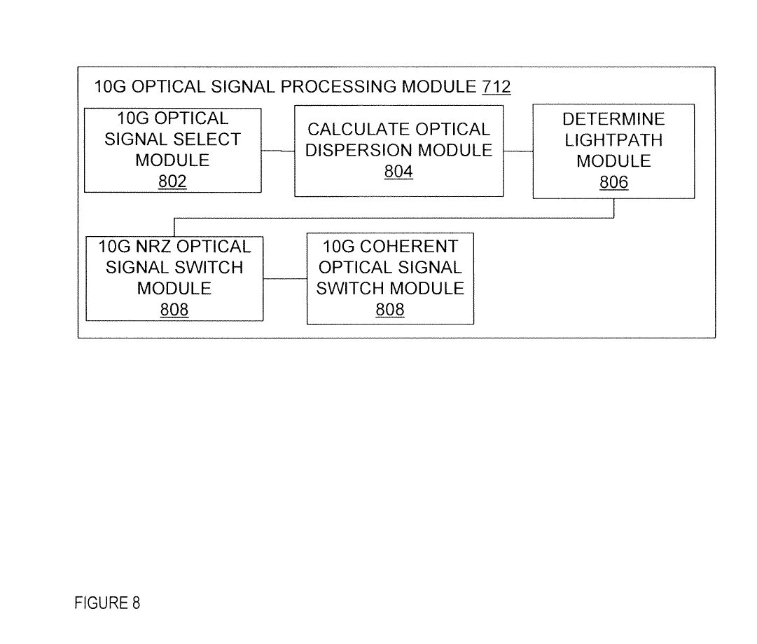

FIG. 8 is a block diagram illustrating an exemplary 10 G optical signal processing module 714 that can route a 10 G signal as used in FIG. 7 according to one embodiment of the invention. In FIG. 8, 10 G optical signal processing module 714 includes 10 G optical signal select module 802, calculate optical dispersion module 804, determine lightpath module 806, 10 G NRZ optical signal switch module 808, and 10 G coherent optical signal switch module 810. In one embodiment, the 10 G optical signal select module 802 selects the 10 G optical signal as described in FIG. 4, block 402 above. In one embodiment, the calculate optical dispersion module 804 calculates the optical dispersion of the 10 G optical signal as described in FIG. 4, block 404 above. In one embodiment, the determine lightpath module 806 determines if there is a suitable lightpath for the 10 G optical signal as described in FIG. 4, block 406 above. In one embodiment, the 10 G NRZ optical signal switch module 808 switches the 10 G NRZ optical signal as a wavelength to a 10 G port as described in FIG. 4, block 408 above. In one embodiment, the 10 G coherent optical signal switch module 810 switches the 10 G optical signal to a coherent transceiver as described in FIG. 4, block 410 above.

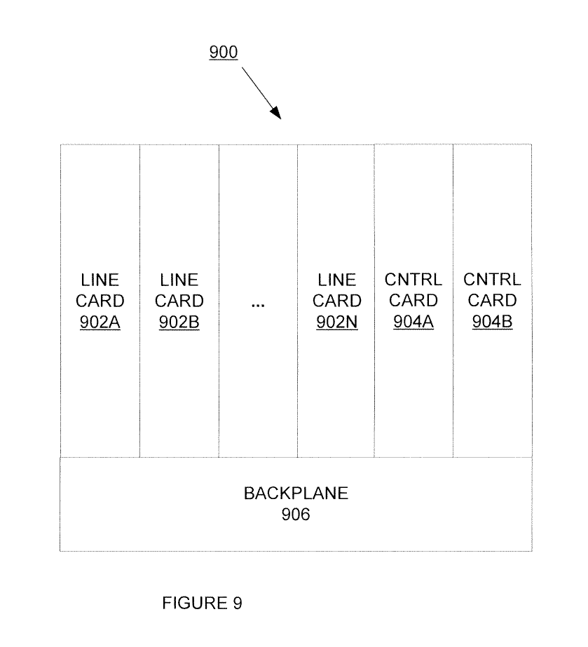

FIG. 9 is a block diagram illustrating an exemplary network element that can route 10 G and 10/40/100 G signals that were multiplexed as used in FIG. 2 according to one embodiment of the system. In FIG. 9, backplane 906 couples to line cards 902A-N and controller cards 904A-B. While in one embodiment, controller cards 904A-B control the processing of the traffic by line cards 902A-N, in alternate embodiments, controller cards 904A-B, perform the same and/or different functions (controlling coherent and non-coherent optical signal detection, etc.). Line cards 902A-N process and forward traffic according to the policies received from controller cards 904A-B. In one embodiment, one or more line cards 902A-N include)a DSP and can process data as described in FIGS. 2-4. For example and in one embodiment, one of the line cards 902A-N can receive a multiplexed signal that is a mix of coherent and non-coherent optical signals and route these optical signals to appropriate ports on other line cards as illustrated in FIGS. 2-4. It should be understood that the architecture of the network element 900 illustrated in FIG. 9 is exemplary, and different combinations of cards may be used in other embodiments of the invention.

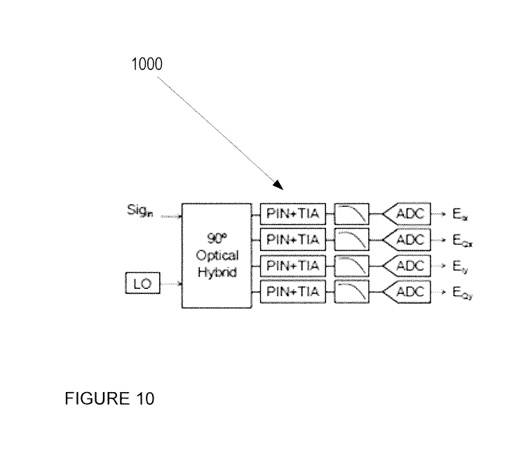

FIG. 10 is a block diagram of an OOK coherent receiver hardware 1000 according to one embodiment of the invention. In FIG. 10, the OOK coherent receiver optical frontend 1000, which consists of a polarization diverse 90° optical hybrid that mixes the incoming signal and the local oscillator together to obtain the I and Q components for each polarization state. These four signals are then detected, AC coupled and lowpass filtered before analogue to digital conversion takes place at nominally two samples per symbol.

A coherent receiver front end used for recovery of a DP-QPSK signal appears as shown as in FIG. 10. This same architecture can be used to recover a 10 G NRZ optical signal. In one embodiment, the 10 G NRZ optical signal is an optical signal that was intended for DWDM applications, specifically that the light source is a laser that meets the requirement for operation on the ITU frequency grid defined in G.694.1. The output from a transmitter using such a laser will be (a) polarized, and (b) have a lasing frequency is restricted to a narrow range.

When a 40 Gigabit per second DP-QPSK signal is delivered to such a receiver, there are four 10 Gigabit per second signals emerging from the ADCs that are sent to a subsequent DSP section for processing. The output of that DSP is 4 fully recovered, 10 Gigabit per second datastreams.

In one embodiment, the difference between a receiver that recovers a 10 G NRZ signal and one that recovers a 40 G DP-QPSK signal is in the following DSP block. The coherent receiver still delivers the output from the four ADCs to the DSP but the output of the DSP is now a single recovered 10 gigabit per second datastream.

The DSP section is a compute intensive entity capable of performing many high speed complex mathematical functions simultaneously. The major functions that have to be performed are identification and compensation of the offset in frequency between the source laser operating frequency and that of the local oscillator, and compensation of large, slowly changing dispersion (arising for example from electrical filtering, component frequency response and chromatic dispersion), compensation of smaller, rapidly changing dispersion (arising for example from polarization mode dispersion), compensation for changes in polarization state during propagation, demodulation and identification of the digital bit pattern from the compensated signal. All these functions need to be done for both the DP-QPSK and NRZ modulation formats but because of the difference in modulation format, the algorithms used will be different, particularly for the identification of the laser-local oscillator offset and demodulation algorithms.

Just as different DP-QPSK implementations will have many different algorithms to recover the signal, so too there will be multiple ways to achieve the successful recovery of the NRZ signal using a coherent receiver.

In one embodiment, it should be noted that because the coherent receiver front end is the same as DP-QPSK receivers, the 10 G NRZ coherent receiver will have similar capabilities. In particular, the 10 G coherent receiver be able to take advantage of the ability of coherent receivers to select the wavelength it wants to recover simply by tuning its local oscillator to the desired wavelength (i.e. it can incorporate some of the demultiplexing functions which formerly resided in an external demux).

For example, while the flow diagrams in the figures show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

1. A method of transmitting a 10 G non-return to zero (NRZ) optical signal over a long distance between a 10 G NRZ optical source and a 10 G digital coherent receiver, the method comprising:
receiving the 10 G NRZ optical signal from the 10 G NRZ optical source, wherein the 10 G NRZ optical signal has an accumulated dispersion that is greater than a dispersion tolerance of an incoherent 10 G NRZ optical receiver; and
recovering the 10 G NRZ optical signal using the 10 G digital coherent receiver.

2. The method of claim 1, further comprising:
transmitting the recovered 10 G NRZ optical signal to the incoherent 10 G NRZ optical receiver.

3. The method of claim 1, wherein the receiving comprises:
coherently receiving the 10 G NRZ optical signal using the digital coherent receiver.

4. The method of claim 1, wherein the 10 G NRZ optical signal is polarized and has a narrow linewidth.

5. The method of claim 1, wherein the long distance is greater than eighty kilometers.

6. The method of claim 1, wherein the recovering of the 10 G NRZ optical signal comprises:
recovering the 10 G NRZ optical signal using the phase and amplitude information of the 10 G NRZ optical signal.

7. The method of claim 1, wherein the recovering of the 10 G NRZ optical signal comprises:
polarization tracking of the 10 G NRZ optical signal;
phase detection of the 10 G NRZ optical signal; and
linear distortion compensation of the 10 G NRZ optical signal.

8. The method of claim 1, wherein the recovered 10 G NRZ signal is used to directly modulate a laser that is within the dispersion tolerance of the incoherent 10 G NRZ optical receiver.

9. A 10 G digital coherent receiver to recover a 10 G non-return to zero (NRZ) optical signal over a long distance from a 10 G NRZ optical source, the 10 G digital coherent receiver comprising:
a receiver front end to receive the 10 G NRZ optical signal from the 10 G NRZ optical source, wherein the 10 G NRZ optical signal has an accumulated dispersion that is greater than a dispersion tolerance of an incoherent 10 G NRZ optical receiver; and
a digital signal processor to recover the 10 G NRZ optical signal.

10. The 10 G digital coherent receiver of claim 9, wherein the receiver front end is to receive the 10 G NRZ optical signal coherently and the receiver front end is further to combine the incoming 10 G NRZ signal with light from a local oscillator in an optical phase hybrid prior to a resultant four optical components of the 10NRZ optical signal being delivered to four photodetectors. .

11. The 10 G digital coherent receiver of claim 9, wherein the 10 G NRZ optical signal is polarized and has a narrow linewidth.

12. The 10 G digital coherent receiver of claim 9, wherein the long distance is greater than eighty kilometers.

13. A network that transports a phase-modulated optical signal and a 10 G non-return to zero (NRZ) optical signal over a long distance without a use of a dispersion compensating module (DCM) to fully compensate the 10 G NRZ optical signal, the network comprising:
a phase modulated optical source that generates the phase modulated optical signal having a first wavelength;
a 10 G NRZ optical source that generates the 10 G NRZ optical signal having a second wavelength;
a section of optical fiber, coupled to the phase modulated and 10 G NRZ optical sources, that transports the phase modulated and 10 G NRZ optical signals as a multiplexed optical signal;
a first coherent optical receiver that receives the 10 G NRZ optical signal, wherein the 10 G NRZ optical signal has an accumulated dispersion that is greater than a dispersion tolerance of an incoherent 10 G NRZ optical receiver, and recovers the 10 G NRZ optical signal; and
a second coherent optical receiver that receives the phase modulated optical signal.

14. The network of claim 13, further comprising:
a multiplexer, coupled to the one optical fiber, that multiplexes the phase modulated and 10 G NRZ optical signals into the multiplexed optical signal.

15. The network of claim 14, further comprising:
a demultiplexer, coupled to the one optical fiber, that demultiplexes the multiplexed optical signal into the phase modulated and 10 G NRZ optical signals.

16. The network of claim 13, further comprising:
a switch, coupled to the demultiplexer, the first coherent optical receiver, and the second optical receiver, that delivers the 10 G NRZ optical signal to the first coherent optical receiver and the phase modulated optical signal to the second optical receiver.

17. The network of claim 13, further comprising:
an incoherent 10 G NRZ optical receiver, coupled to the first coherent optical receiver, that receives the recovered 10 G NRZ optical signal from the first coherent optical receiver.

18. The network of claim 17, wherein the recovered 10 G NRZ signal modulates a laser that is within the dispersion tolerance of the incoherent 10 G NRZ optical receiver.

19. The network of claim 13, wherein the 10 G NRZ optical signal is polarized and has a narrow linewidth.

20. The network of claim 13, wherein the long distance is greater than eighty kilometers.
